(19) United States
(12) Patent Application Publication
(10) Pub. No.: US 2009/0067198 A1
(43) Pub. Date: Mar. 12, 2009

(54) CONTACTLESS POWER SUPPLY

(76) Inventors: David Jeffrey Graham, Cranburry Township, PA (US); Jesse Frederick Goellner, Pittsburgh, PA (US); Michael Thomas McElhinny, Port Vue, PA (US); Alexander Brailovsky, Cheswick, PA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/200,422

(22) Filed: Aug. 28, 2008

Related U.S. Application Data
(60) Provisional application No. 60/966,647, filed on Aug. 29, 2007.

(51) Int. Cl. H02J 17/00; H02M 7/00

(52) U.S. Cl. 363/8; 307/104

(57) ABSTRACT

A system includes a first device configured to receive a first wireless power associated with a first electromagnetic wave from a wireless power source. The first device is configured to convert the first wireless power to a first DC power, store the first DC power, and convert the first DC power stored in the first device to a second wireless power associated with a second electromagnetic wave. The system includes a second device configured to receive the second wireless power from the first device. The second device is configured to convert the second wireless power to a second DC power. The first device can receive the first wireless power at a first location and can convert the first DC power stored in the first device to the second wireless power at a second location different from the first location.

### CROSS-REFERENCE TO RELATED APPLICATIONS

This application claims priority to U.S. Provisional Patent Application Ser. No. 60/966,647, entitled “Contactless Power Supply,” filed Aug. 29, 2007. The above-identified U.S. patent application is hereby incorporated herein by reference in its entirety.

This application is related to U.S. Pat. No. 7,027,311, entitled “Method And Apparatus For A Wireless Power Supply,” filed Oct. 15, 2004; U.S. patent application Ser. No. 11/356,892, entitled “Method, Apparatus And System For Power Transmission,” filed Feb. 16, 2006; U.S. patent application Ser. No. 11/438,508, entitled “Power Transmission Network,” filed May 22, 2006; U.S. patent application Ser. No. 11/447,412, entitled “Powering Devices Using RF Energy Harvesting,” filed Jun. 6, 2006; U.S. patent application Ser. No. 11/481,499, entitled “Power Transmission System,” filed Jul. 6, 2006; U.S. patent application Ser. No. 11/584,983, entitled “Method And Apparatus For High Efficiency Rectification For Various Loads,” filed Oct. 23, 2006; U.S. patent application Ser. No. 11/601,142, entitled “Radio-Frequency (RF) Power Portal,” filed Nov. 17, 2006; U.S. patent application Ser. No. 11/651,818, entitled “Pulse Transmission Method,” filed Jan. 10, 2007; U.S. patent application Ser. No. 11/699,148, entitled “Power Transmission Network And Method,” filed Jan. 29, 2007; U.S. patent application Ser. No. 11/705,303, entitled “Implementation Of An RF Power Transmitter And Network,” filed Feb. 12, 2007; U.S. patent application Ser. No. 11/494,108, entitled “Method And Apparatus For Implementation Of A Wireless Power Supply,” filed Jul. 27, 2009; U.S. patent application Ser. No. 11/811,081, entitled “Wireless Power Transmission,” filed Jun. 8, 2007; U.S. patent application Ser. No. 11/881,203, entitled “RF Power Transmission Network And Method,” filed Jul. 26, 2007; U.S. patent application Ser. No. 11/897,346, entitled “Hybrid Power Harvesting And Method,” filed Aug. 30, 2007; U.S. patent application Ser. No. 11/897,345, entitled “RF Powered Specialty Lighting, Motion, Sound,” filed Aug. 30, 2007; U.S. patent application Ser. No. 12/006,547, entitled “Wirelessly Powered Specialty Lighting, Motion, Sound,” filed Jan. 3, 2008; U.S. patent application Ser. No. 12/005,696, entitled “Powering Cell Phones and Similar Devices Using RF Energy Harvesting,” filed Dec. 28, 2007; U.S. patent application Ser. No. 12/005,737, entitled “Implementation of a Wireless Power Transmitter and Method,” filed Dec. 28, 2007; U.S. patent application Ser. No. 12/048,529, entitled “Multiple Frequency Transmitter, Receiver, and System Thereof,” filed Mar. 14, 2008; U.S. patent application Ser. No. 12/125,516, entitled “Item and Method for Wirelessly Powering the Item,” filed May 22, 2008; and U.S. patent application Ser. No. 12/125,532, entitled “Smart Receiver and Method,” filed May 22, 2008. The above-identified U.S. patent and U.S. patent applications are hereby incorporated herein by reference in their entirety.

### BACKGROUND

The systems and methods disclosed relate generally to wireless power transfer and more particularly to a power supply that receives and sends power wirelessly.

In many of today's consumer, commercial, and/or industrial applications, a contactless battery or contactless source of power can offer many advantages over currently available options. For example, when a battery is connected to the terminals of a device or when a battery is removed from a device, a small arc or spark can result from an electrical potential between a terminal of the device and a terminal of the battery. In most consumer applications, sparks produced when replacing a used battery are not typically dangerous. In some commercial and/or industrial environments, however, sparks produced when changing or replacing used batteries can result in hazardous or unsafe conditions and/or injury. For example, changing batteries in mines, refineries, chemical plants, and/or locations handling flammable gasses may be restricted or prohibited to avoid the possibility of starting a fire or producing an explosion.

In another example, it is desirable in many consumer, commercial, and/or industrial applications to use a device in wet or humid conditions. In such conditions, however, an electrical current can easily flow between a battery's terminals and the energy stored in a battery can be drained even when the device being powered by the battery is not consuming electricity. In this regard, additional components or parts, such as gaskets or seals, for example, may be necessary to prevent moisture from entering the compartment within which the battery is disposed.

In yet another example, a battery's terminals can corrode or wear over time when exposed to certain conditions, such as wet and humid conditions, for example. Reducing or eliminating the effects of corrosion and/or wear on the battery's terminals can increase the useful life of the battery.

Thus, a need exists for batteries or sources of power that can be used in multiple conditions such as hazardous environments, wet or humid environments, and/or corrosive environments.

### SUMMARY

In one or more embodiments, a system includes a first device configured to receive a first wireless power associated with a first electromagnetic wave from a wireless power source. The first device is configured to convert the first wireless power to a first DC power, store the first DC power, and convert the first DC power stored in the first device to a second wireless power associated with a second electromagnetic wave. The system includes a second device configured to receive the second wireless power from the first device. The second device is configured to convert the second wireless power to a second DC power. In some embodiments, the first device can receive the first wireless power at a first location and can convert the first DC power stored in the first device to the second wireless power at a second location different from the first location.

### BRIEF DESCRIPTION OF THE DRAWINGS

FIGS. 1A and 1B are system block diagrams of a contactless power supply receiving and sending wireless power at different locations, according to an embodiment.

FIG. 2A is a system block diagram of a contactless power supply receiving wireless power from a wireless power source, according to an embodiment.

FIG. 2B is a system block diagram of a contactless power supply sending wireless power to a device, according to an embodiment.

FIG. 2C is a system block diagram of a contactless power supply sending wireless power to a device, according to another embodiment.

FIGS. 3A and 3B are system block diagrams of a contactless power supply removably attached to a device, according to embodiments.

FIGS. 4A and 4B are system block diagrams of a contactless power supply removably attached to a wireless power source, according to embodiments.

FIG. 5A is a system block diagram of a contactless power supply receiving wireless power from a wireless power source via capacitive coupling, according to an embodiment.

FIG. 5B is a system block diagram of a contactless power supply sending wireless power to a device via capacitive coupling, according to an embodiment.

FIGS. 6A and 6B are system block diagrams of a contactless power supply removably attached to a device, according to other embodiments.

FIG. 7 is a system block diagram of a contactless power supply, according to an embodiment.

FIG. 8 is a system block diagram of a contactless power supply, according to another embodiment.

FIGS. 9A and 9B are system block diagrams of a contactless power supply receiving wireless power from a wireless power source and removably attached to a device, according to an embodiment.

FIG. 10 is a flow chart illustrating a method for wireless transmission of power using a contactless power supply, according to an embodiment.

### DETAILED DESCRIPTION

The methods and systems disclosed herein describe a wireless power source, a contactless power supply, and a device to be wirelessly powered by the contactless power supply. The contactless power supply can be referred to as a contactless battery, for example.

In one embodiment, a system includes a first device configured to receive a first wireless power associated with a first electromagnetic wave from a wireless power source. The first device is configured to convert the first wireless power to a first DC power, to store the first DC power, and to convert the first DC power stored in the first device to a second wireless power associated with a second electromagnetic wave via an antenna. The system includes a second device configured to receive the second wireless power from the first device. The second device is configured to convert the second wireless power to a second DC power. The second device can be configured to store the second DC power. The first device can be, for example, a contactless power supply, and the second device can be, for example, a device to be powered by the contactless power supply.

The first device can be configured to receive the first wireless power associated with the first electromagnetic wave at a first location. The first device can be configured to convert the first DC power stored in the first device to the second wireless power at a second location different from the first location. In one example, the first device can include a sensor module configured to detect the second device and an activation module configured to enable at least a portion of the first device upon the second device being detected by the sensor module. In another example, the first device can include a user interface configured to detect a user input and an activation module configured to enable at least a portion of the first device based on the user input.

In another embodiment, a system includes a first device configured to receive a first wireless power from a power source. The first device is configured to convert the first wireless power to a first DC power. The first device is configured to store the first DC power. The first device is configured to convert the first DC power stored in the first device to a second wireless power. The system includes a second configured to receive the second wireless power from the first device. The second device configured to convert the second wireless power to a second DC power.

In another embodiment, a system includes a first device having capacitive plates configured to receive a first wireless power from a power source via capacitive coupling. The first device is configured to convert the first wireless power to a first DC power, to store the first DC power, and to convert the first DC power stored in the first device to a second wireless power via capacitive coupling. The system includes a second device having capacitive plates configured to receive the second wireless power from the first device. The second device is configured to convert the second wireless power to a second DC power. The first device can be, for example, a contactless power supply; the second device can be, for example, a device to be powered by the contactless power supply.

The capacitive plates of the first device can include a first set of capacitive plates configured to capacitively couple the first device and the power source, and a second set of capacitive plates configured to capacitively couple the first device and the second device. The first device can include a switch having a first position and a second position. The capacitive plates of the first device are configured to capacitively couple the first device and the power source when the switch is in the first position. The capacitive plates of the first device are configured to capacitively couple the first device and the second device when the switch is in the second position.

In another embodiment, a method includes moving a first device to a first location within a wireless-power threshold associated with a power source. The first device is configured to receive a first wireless power from the power source when in the first location and to convert the first wireless power to a first DC power. The method includes moving the first device to a second location such that a second device is within a wireless-power threshold associated with the first device. The first device is configured to convert the first DC power to a second wireless power when in the second location. The second device is configured to receive the second wireless power from the first device and to convert the second wireless power to a second DC power. The first device can be, for example, a contactless power supply; the second device can be, for example, a device to be powered by the contactless power supply.

In another embodiment, an apparatus includes a receiver, a power storage module, a transmitter, and a housing. The receiver is configured to receive a first wireless power and to convert the first wireless power to a first DC power. The power storage module is configured receive the first DC power from the receiver and to store the first DC power. The transmitter is configured to receive the first DC power from the power storage module and to convert the first DC power to a second wireless power via an antenna. The receiver, the power storage module, and the transmitter are disposed within the housing. The transmitter is configured to transmit the second wireless power via the antenna to a device separate from the housing such that the device receives the second wireless power from the transmitter and converts the second wireless power to a second DC power.

It is noted that, as used in this written description and the appended claims, the singular forms “a,” “an” and “the” include plural referents unless the context clearly dictates otherwise. Thus, for example, the term “a wave” is intended to mean a single wave or a combination of waves.

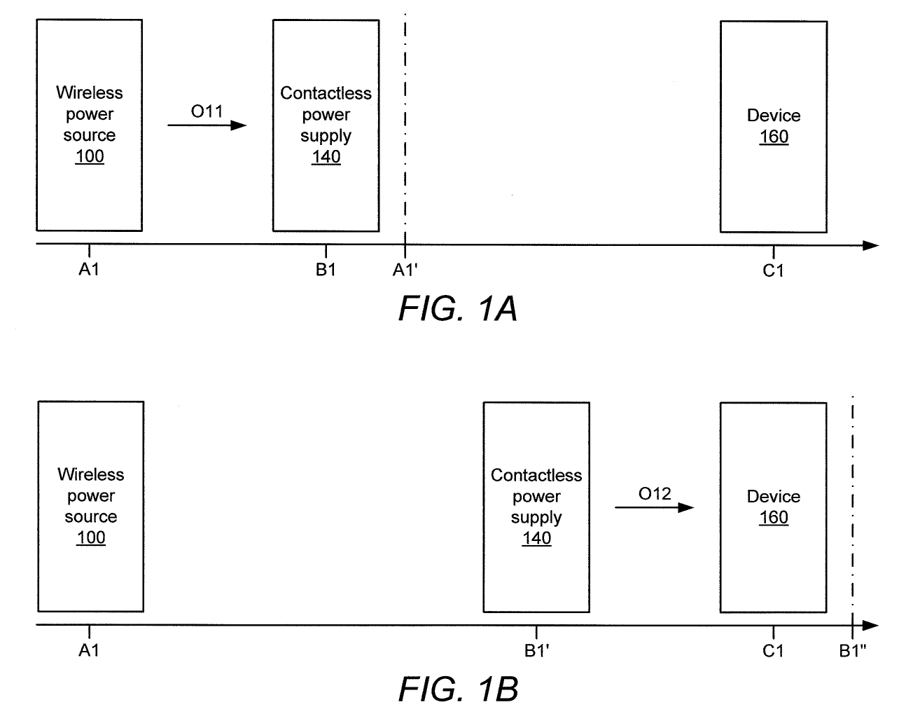

FIGS. 1A and 1B are system block diagrams of a contactless power supply 140 receiving wireless power from a wireless power source 100 while at one location and sending wireless power to a device 160 while at another location, according to an embodiment. As shown in FIG. 1A, the wireless power source 100 is at location A1, the contactless power supply 140 is at location B1, and the device 160 is at location C1. The wireless power source 100 is configured to produce an output O11 having, for example, one or more electromagnetic waves associated with a frequency band within the radio frequency (RF) spectrum. The contactless power supply 140 is configured to receive the output O11 from the wireless power source 100 while at location B1. The contactless power supply 140 is configured to convert the wireless power (e.g., RF electromagnetic wave) associated with the output O11 to a DC power (e.g., RF-to-DC conversion). The contactless power supply 140 is configured to store the DC power.

To provide efficient wireless power transfer between the wireless power source 100 and the contactless power supply 140, it is desirable that the contactless power supply 140 be located near the wireless power source 100 such that the wireless power associated with the output O11 at the location of the contactless power supply 140 (i.e., location B1) is above a predetermined wireless-power threshold. In this regard, the predetermined wireless-power threshold can be associated with a maximum distance between the wireless power source 100 and the contactless power supply 140 that results in sufficient wireless power transfer from the wireless power source 100 to the contactless power supply 140. For example, FIG. 1A shows a location A1′ that corresponds to a maximum distance away from the wireless power source 100 within which to place the contactless power supply 140 to ensure that sufficient wireless power is transferred to the contactless power supply 140 from the wireless power source 100 via the output O11. In this regard, sufficient wireless power transfer can refer to receiving an amount or level of wireless power at the contactless power supply 140 that is above a floor or noise level such that the contactless power supply 140 can convert the wireless power received to a DC power. In some embodiment, the contactless power supply 140 can be coupled to the wireless power source 100.

FIG. 1B shows the contactless power supply 140 at location B1′ further away from the wireless power source 100 and closer to the device 160 than the distances shown in FIG. 1A. The contactless power supply 140 is configured to produce an output O12 having, for example, one or more electromagnetic waves associated with a frequency band in the RF spectrum. In some embodiments, the frequency band associated with the output O12 can be different from the frequency band associated with the output O11 from (or the same as) the wireless power source 100. The device 160 is configured to receive the output O12 from the contactless power supply 140. The device 160 is configured to convert the wireless power associated with the output O12 to a DC power. The device 160 can be configured to store the DC power and/or use the DC power for operations.

Similar to that described above with respect to the wireless power source 140, for efficient wireless power transfer from the contactless power supply 140 to the device 160, it is desirable that the device 160 be located near the contactless power supply 140 such that the wireless power associated with the output O12 at the location of the device 160 (i.e., location C1) is above a predetermined wireless-power threshold. In this regard, the predetermined wireless-power threshold can be associated with a maximum distance between the contactless power supply 140 and the device 160 that results in sufficient wireless power transfer from the contactless power supply 140 to the device 160. For example, FIG. 1B shows a location B1″ that corresponds to a maximum distance away from the contactless power supply 140 (at location B1′) within which to place the device 160 to ensure that sufficient wireless power is transferred to the device 160 from the contactless power supply 140 via the output O12. In this regard, sufficient wireless power transfer can refer to receiving an amount or level of wireless power at the device 160 that is above a floor or noise level such that the device 160 can convert the wireless power received to a DC power. The floor or noise level can be associated with, for example, a power level necessary to operate the electronics of the device 160. In this regard, the wireless power received needs to exceed the floor or noise level to enable the operation of the device 160.

In some embodiments, the maximum distance between the wireless power source 100 and the contactless power supply 140 and associated with the predetermined wireless-power threshold of the wireless power source 100 can be different from the maximum distance between the contactless power supply 140 and the device 160 and associated with the predetermined wireless-power threshold of the contactless power supply 140. In one example, a charging reach or charging distance covered by the contactless power supply 140 is shorter than the charging reach or charging distance covered by the wireless power source 100. In another example, a charging reach or charging distance covered by the contactless power supply 140 is longer than the charging reach or charging distance covered by the wireless power source 100.

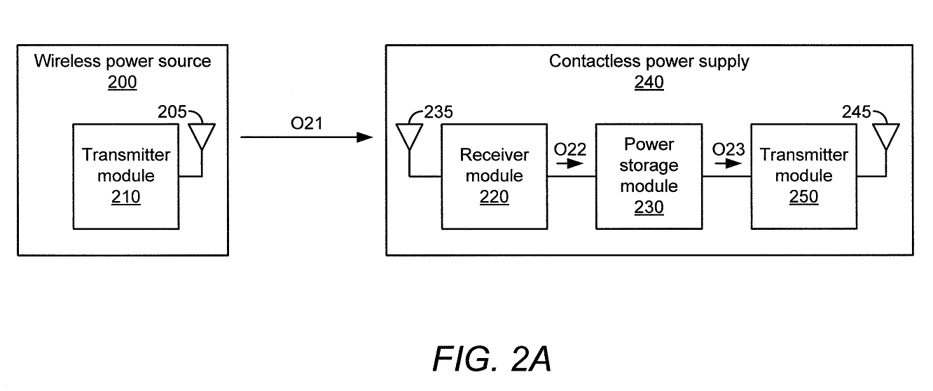

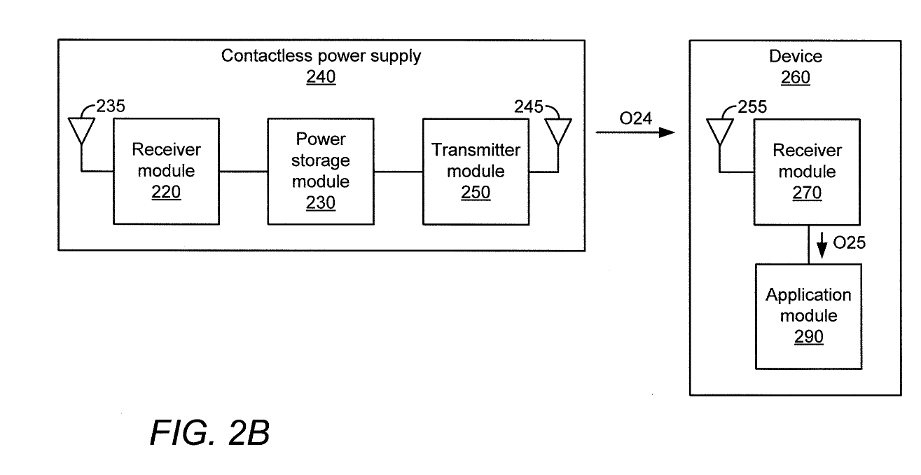

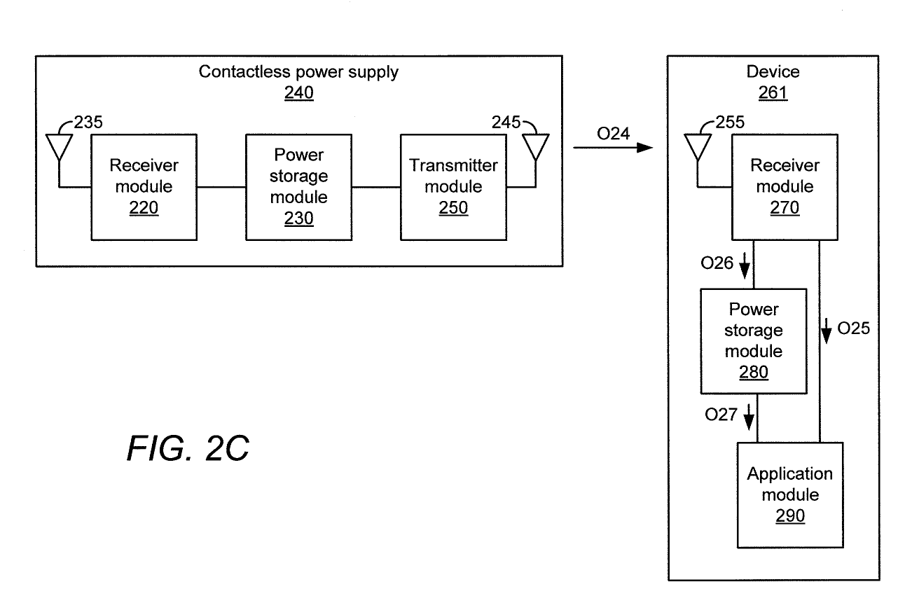

FIG. 2A is a system block diagram of a contactless power supply 240 receiving wireless power from a wireless power source 200, according to an embodiment. The wireless power source 200 includes a transmitter module 210 and an antenna 205. The contactless power supply 240 includes a receiver module 220, a power storage module 230, a transmitter module 250, and antennas 235 and 245. In some embodiments, the wireless power source 200 can include a housing (not shown) within which the transmitter module 210 and the antenna 205 are disposed. In some embodiments, the contactless power supply 240 can include a housing (not shown) within which the receiver module 220, the power storage module 230, the transmitter module 250, and antennas 235 and 245 are disposed. The housing of the wireless power source 200 and/or the housing of the contactless power supply 240 can be sealed (e.g., hermetically sealed) to reduce wear and/or the effects caused by, for example, certain environmental conditions. In some instances, a protective layer (e.g. an epoxy layer) can be placed on the outer portion of the wireless power source 200 and/or the contactless power supply 240.

The transmitter module 210 of the wireless power source 200 is configured to produce an output O21 via the antenna 205 to transfer power wirelessly from the wireless power source 200 to the contactless power supply 240. The output O21 includes, for example, one or more electromagnetic waves associated with a frequency band within the RF spectrum. The transmitter module 210 can be hardware-based (e.g., circuit system, processor, application-specific integrated circuit (ASIC), field programmable gate array (FPGA)) or hardware-based and software-based (e.g., set of instructions executable at a processor, software code). The antenna 205 is configured to transmit the output O21. The antenna 205 can be a dipole antenna, for example. The antenna 205 can be optimized, for example, to transmit electromagnetic waves at or near the center or nominal frequency associated with the output O21.

The receiver module 220 of the contactless power supply 240 is configured to receive at least a portion of the output O21 via the antenna 235. The receiver module 220 is configured to convert the received portion of the output O21 to a DC power. Said another way, the receiver module 220 converts power received from one or more electromagnetic waves to a DC power (e.g., RF-to-DC conversion). In some embodiments, the receiver module 220 can be configured to receive one or more electromagnetic waves from a source other than the wireless power source 200 (e.g., ambient power) and convert the power associated with such electromagnetic waves to a DC power. The receiver module 220 is configured to produce an output O22 having an associated DC power. The receiver module 220 is configured to provide the output O22 to the power storage module 230.

The power storage module 230 is configured to receive and store DC power or energy produced by receiver module 220. The power storage module 230 can include a rechargeable battery, for example, such that the DC power can be replenished (e.g., recharge the battery). The power storage module 230 is configured to produce an output O23 to transfer at least a portion of the DC power stored in the power storage module 230 to the transmitter module 250. The transmitter module 250 is configured to receive the output O23 from the power storage module 230. The transmitter module 250 is configured to convert the DC power from the output O23 to one or more electromagnetic waves (not shown in FIG. 2A) via the antenna 245 for wireless power transfer. The receiver module 220, the power storage module 230, and/or the transmitter module 250 can be hardware-based (e.g., circuit system, processor, application-specific integrated circuit (ASIC), field programmable gate array (FPGA)) or hardware-based and software-based (e.g., set of instructions executable at a processor, software code).

FIG. 2B is a system block diagram of the contactless power supply 240 described above with respect to FIG. 2A sending wireless power to a device 260, according to an embodiment. The contactless power supply 240 is configured to produce an output O24 via the antenna 245 to transfer power wirelessly to the device 260. The output O24 includes, for example, one or more electromagnetic waves associated with a frequency band within the RF spectrum. In some embodiments, the frequency band associated with the output O24 can be different from (or same as) the frequency band associated with the output O21 from the wireless power source 200 as described above with respect to FIG. 2A.

The device 260 includes a receiver module 270, an application module 290, and an antenna 255. In some embodiments, the device 260 can include a housing (not shown) within which the receiver module 270, the application module 290, and/or the antenna 255 are disposed. The housing of the device 260 can be sealed (e.g., hermetically sealed). In some instances, a protective layer can be placed on the outer portion of the device 260.

The receiver module 270 is configured to receive at least a portion of the output O24 from the transmitter module 250 via the antenna 255. The receiver module 270 is configured to convert the received portion of the output O24 to a DC power. In some embodiments, the receiver module 270 can be configured to receive one or more electromagnetic waves from a source other than the contactless power supply 240 (e.g., ambient power) and convert power associated with such electromagnetic waves to a DC power. The receiver module 270 is configured to produce an output O25 having an associated DC power. The receiver module 270 is configured to provide the output O25 to the application module 290.

The application module 290 is configured to receive the output O25 having an associated DC power from the receiver module 270. The application module 290 is configured to perform one or more operations associated with an application such as consumer, commercial, and/or industrial application based on the DC power received from the receiver module 270. The receiver module 270 and/or the application module 290 can be hardware-based or hardware-based and software-based.

FIG. 2C is a system block diagram of the contactless power supply 240 described above with respect to FIG. 2A sending wireless power to a device 261, according to an embodiment. The device 261 includes the receiver module 270, the application module 290, the antenna 255, and a power storage module 280. In some embodiments, the device 261 can include a housing (not shown) within which the receiver module 270, the power storage module 280, the application module 290, and/or the antenna 255 are disposed. The housing of the device 261 can be sealed (e.g., hermetically sealed). In some instances, a protective layer can be placed on the outer portion of the device 261.

In addition to the output O25, the receiver module 270 is configured to produce an output O26 having an associated DC power. The receiver module is configured to provide the output O26 to the power storage module 280. The power storage module 280 is configured to receive and store DC power or energy produced by receiver module 270. The power storage module 280 can include a rechargeable battery, for example, such that the DC power can be replenished (e.g., recharge the battery). The power storage module 280 is configured to produce an output O27 to transfer at least a portion of the DC power stored in the power storage module 280 to the application module 290.

The receiver module 270 is configured to determine whether to send DC power to the power storage module 280 or to send DC power to the application module 290 to operate the application module 290. In this regard, the receiver module 270 can perform one or more power management operations that optimize the usage and/or transfer of DC power according to the DC power available from the output O24, the DC power stored in the power storage module 280, and/or the power requirements of the application module 290. For example, the receiver module 270 can be configured to regulate the DC power. An example of DC power regulation is disclosed in U.S. patent application Ser. No. 11/447,412, entitled “Powering Devices Using RF Energy Harvesting,” filed Jun. 6, 2006, which is incorporated herein by reference in its entirety.

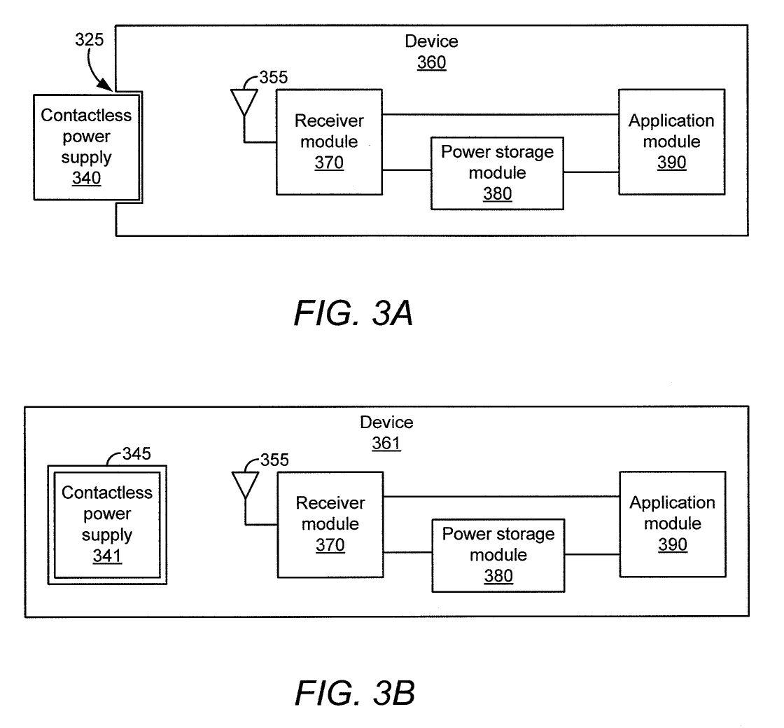

FIGS. 3A and 3B are system block diagrams of a contactless power supply 340 removably attached to devices 360 and 361, respectively, according to other embodiments. The contactless power supply 340 can be similar to the contactless power supplies 140 and 240 described above with respect to FIGS. 1A-2C. The devices 360 and 361 can be similar to the devices 160, 260, and 261 described above with respect to FIGS. 1A-1B and FIGS. 2B-2C. The devices 360 and 361 include a receiver module 370, a power storage module 380, an application module 390, and an antenna 355.

FIG. 3A shows the contactless power supply 340 removably attached to an outer portion 325 of the device 360. The outer portion 325 can correspond to, for example, a bay or cradle configured to be complimentarily fitted to the outer portion of the contactless power supply 340. In some embodiments, the contactless power supply 340 and the device 360 can each include a mating member configured to removably attach the contactless power supply 340 and the device 360. A mating member of the contactless power supply 340 can be complimentarily fitted to a mating member of the device 360. The contactless power supply 340 and the device 360 can each include at least one of a protrusion, a projection, a groove, or a depression configured to complimentarily fit the contactless power supply 340 to the device 360.

FIG. 3B shows the contactless power supply 341 removably attached to an inner portion 345 of the device 361. The inner portion 345 can correspond to, for example, a bay, space, or compartment within the device 361 that is configured to be complimentarily fitted with the outer portion of the contactless power supply 341. The device 361 can include a cover or lid (not shown) to enclose (e.g., hermetically seal) the contactless power supply 341 within the inner portion 345 to reduce wear and/or prevent the effects caused by, for example, certain environmental conditions that may affect the operation or performance of the contactless power supply 341. In some embodiments, the contactless power supply 341 and the device 361 can each include a mating member configured to removably attach the contactless power supply 341 and the device 361. A mating member of the contactless power supply 341 can be complimentarily fitted to a mating member of the device 361. The contactless power supply 341 and the device 361 can each include at least one of a protrusion, a projection, a groove, or a depression configured to complimentarily fit the contactless power supply 341 to the device 361. To avoid or reduce the likelihood of causing a spark, for example, the housing, protrusion, projection, groove, and/or depression, can be made of plastic or like material that complimentarily fit.

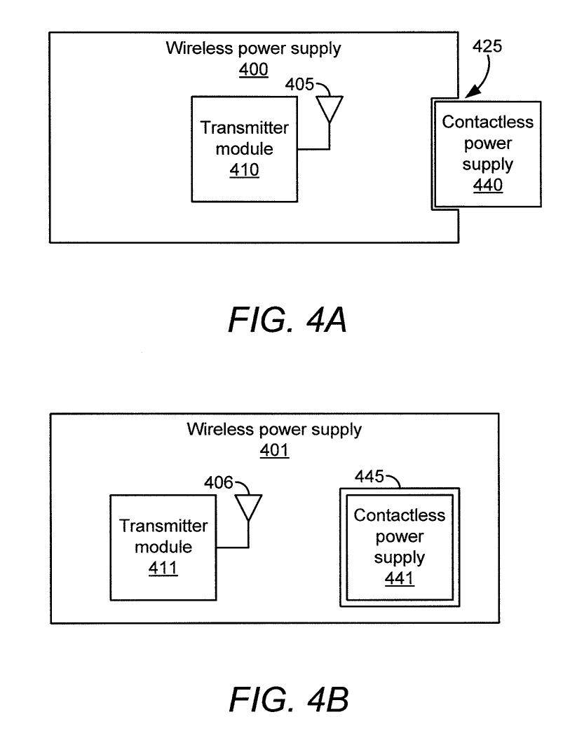

FIGS. 4A and 4B are system block diagrams of a contactless power supply 440 removably attached to wireless power sources 400 and 401, respectively, according to other embodiments. The contactless power supply 440 can be similar to the contactless power supplies 140 and 240 described above with respect to FIGS. 1A-2C. The wireless power sources 400 and 401 can be similar to the wireless power sources 100 and 200 described above with respect to FIGS. 1A-1B and FIGS. 2A-2B.

FIG. 4A shows the contactless power supply 440 removably attached to an outer portion 425 of the wireless power source 400. The outer portion 425 can correspond to, for example, a bay or cradle configured to be complimentarily fitted with the outer portion of the contactless power supply 440. In some embodiments, the contactless power supply 440 and the wireless power source 400 can each include a mating member configured to removably attach the contactless power supply 440 and the wireless power source 400. A mating member of the contactless power supply 440 can be complimentarily fitted to a mating member of the wireless power source 400. The contactless power supply 440 and the wireless power source 400 can each include at least one of a protrusion, a projection, a groove, or a depression configured to complimentarily fit the contactless power supply 440 to the wireless power source 400.

FIG. 4B shows the contactless power supply 440 removably attached to an inner portion 445 of the wireless power source 401. The inner portion 445 can correspond to, for example, a bay, space, or compartment within the wireless power source 401 that is configured to be complimentarily fitted with the outer portion of the contactless power supply 440. The wireless power source 401 can include a cover or lid (not shown) to enclose (e.g., hermetically seal) the contactless power supply 440 within the inner portion 445 to reduce wear and/or reduce the effects caused by, for example, certain environmental conditions that may affect the operation or performance of the contactless power supply 440. In some embodiments, the contactless power supply 440 and the wireless power source 401 can each include a mating member configured to removably attach the contactless power supply 440 and the wireless power source 401. A mating member of the contactless power supply 440 can be complimentarily fitted to a mating member of the wireless power source 4001. The contactless power supply 440 and the wireless power source 401 can each include at least one of a protrusion, a projection, a groove, or a depression configured to complimentarily fit the contactless power supply 440 to the wireless power source 401.

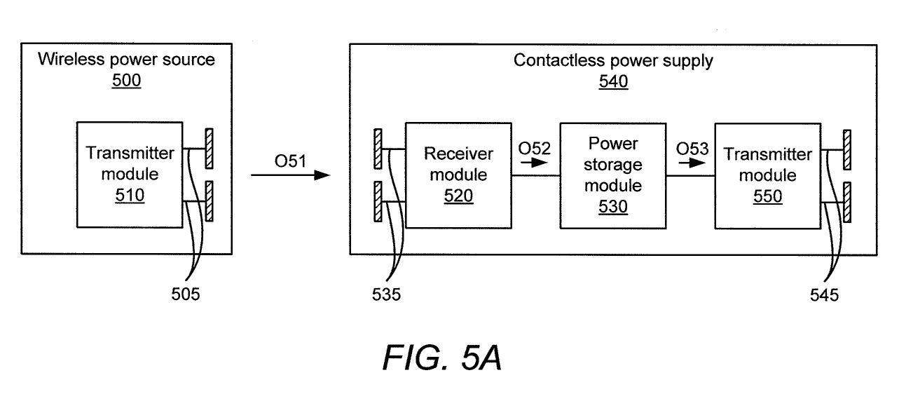

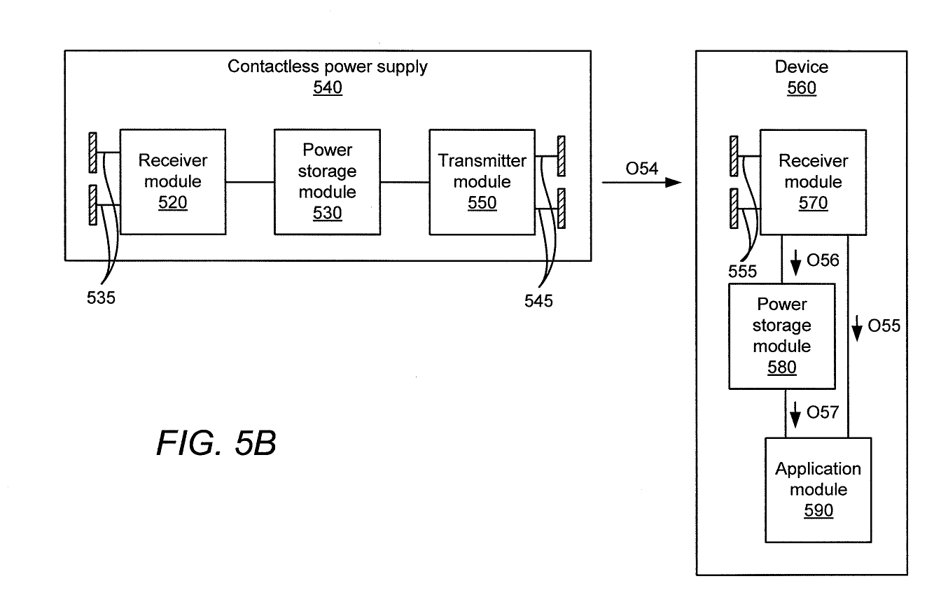

FIG. 5A is a system block diagram of a contactless power supply 540 receiving wireless power from a wireless power source 500 via capacitive coupling, according to an embodiment. The wireless power source 500 includes a transmitter module 510 and capacitive plates 505. The contactless power supply 540 includes a receiver module 520, a power storage module 530, a transmitter module 550, and capacitive plates 535 and 545. In some embodiments, the wireless power source 500 can include a housing (not shown) within which the transmitter module 510 and capacitive plates 505 are disposed. In some embodiments, the contactless power supply 540 can include a housing (not shown) within which the receiver module 520, the power storage module 530, the transmitter module 550, and capacitive plates 535 and 545 are disposed. The housing of the wireless power source 500 and/or the housing of the contactless power supply 540 can be sealed (e.g., hermetically sealed), for example.

The transmitter module 510 of the wireless power source 500 is configured to produce an output O51 via the capacitive plates 505 to transfer power wirelessly to the contactless power supply 540. Power transferred through capacitive plates (i.e., capacitive coupling) occurs via an electric field produced between the capacitive plates 505 of the wireless power source 500 and the capacitive plates 535 of the contactless power supply 540 without physical contact between the sets of capacitive plates. The transmitter module 510 can include active and passive devices (not shown) such as baluns, tuning circuitry, filters, and/or transformers, for example, which allow power to be transferred via the capacitive plates 505. The use of active and passive devices for use in capacitive coupling is described in U.S. Patent Application Ser. No. 61/080,157, entitled “Method and Apparatus for Power Transfer Using Capacitive Coupling in Interchangeable Modules,” filed Jul. 11, 2008, which is incorporated herein by reference in its entirety. The transmitter module 510 can be hardware-based or hardware-based and software-based.

The receiver module 520 of the contactless power supply 540 is configured to receive at least a portion of the output O51 from the wireless power source 500 via the capacitive plates 535. The receiver module 520 is configured to convert the received portion of the output O51 to a DC power. The receiver module 520 is configured to produce an output O52 having an associated DC power. The receiver module 520 is configured to provide the output O52 to the power storage module 530.

The power storage module 530 is similar to the power storage module 230 described above with respect to FIGS. 2A-2C. The power storage module 530 is configured to receive the output O52 from the receiver module 520 and store the DC power. The power storage module 530 is configured to produce an output O53 to transfer at least a portion of the DC power stored in the power storage module 530 to the transmitter module 550.

The transmitter module 550 is configured to receive the output O53 from the power storage module 530. The transmitter module 550 is configured to convert the DC power from the output O53 to an electric field via the capacitive plates 545 for wireless power transfer. The receiver module 520, the power storage module 530, and/or the transmitter module 550 can be hardware-based or hardware-based and software-based.

FIG. 5B is a system block diagram of the contactless power supply 540 sending wireless power to a device 560 via capacitive coupling, according to an embodiment. The device 560 includes a receiver module 570, an application module 590, capacitive plates 555, and, optionally, a power storage module 580. In some embodiments, the device 560 can include a housing (not shown) within which the receiver module 570, the power storage module 580, the application module 590, and/or the capacitive plates 555 are disposed. The housing of the device 560 can be sealed (e.g., hermetically sealed), for example. The power storage module 580 and the application module 590 have similar functionality to the power storage module 280 and the application module 290, respectively, described above with respect to FIG. 2C.

The contactless power supply 540 is configured to produce an output O54 via the capacitive plates 545 to transfer power wirelessly to the device 560. The receiver module 570 of the device 560 is configured to receive at least a portion of the output O54 from the contactless power supply 540 via the capacitive plates 555. The receiver module 570 is configured to convert the received portion of the output O54 to a DC power. The receiver module 570 is configured to produce an output O55 having an associated DC power. The receiver module 570 is configured to provide the output O55 to the application module 590.

The receiver module 570 is configured to produce an output O56 having an associated DC power. When the power storage module 580 is present in the device 560, the receiver module 570 can be configured to provide the output O56 to the power storage module 580. The power storage module 580 is configured to receive and store DC power or energy produced by receiver module 570. The power storage module 580 is configured to produce an output O57 to the application module 590 to transfer at least a portion of the DC power stored in the power storage module 580 to the application module 590. The receiver module 570 can be hardware-based or hardware-based and software-based.

The receiver module 570 is configured to determine whether to send DC power to the power storage module 580 or to send DC power to the application module 590 to operate the application module 590. In this regard, the receiver module 570 can perform one or more power management operations that optimize the usage and/or transfer of DC power according to the DC power available from the output O54, the DC power stored in the power storage module 580, and/or the power requirements of the application module 590.

In another embodiment, a given wireless power source can transfer power to a given contactless power supply via inductive coupling. The contactless power supply can be configured to convert the wireless power received via inductive coupling to a DC power and store the DC power. The contactless power supply can be configured to transfer the stored DC power to a given device via inductive coupling.

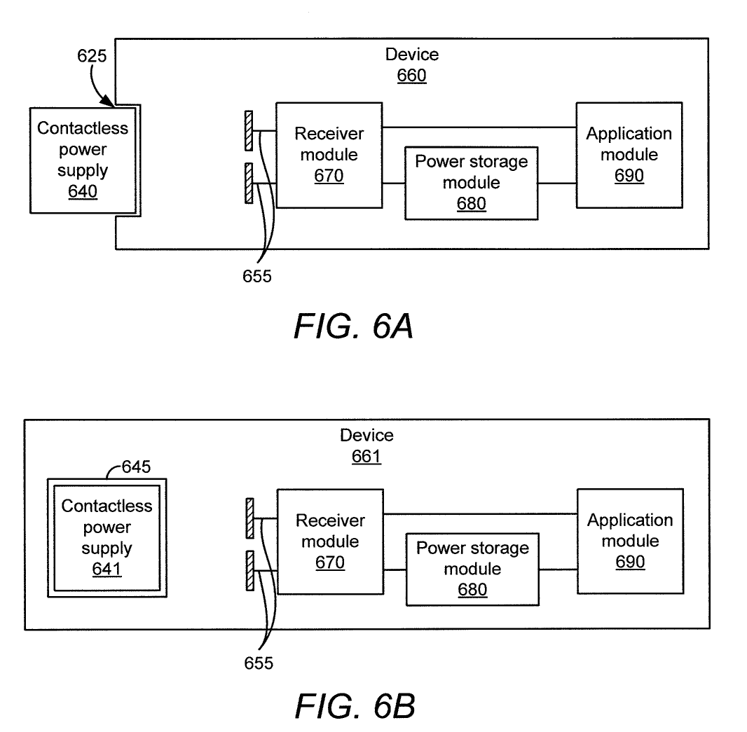

FIGS. 6A and 6B are system block diagrams of contactless power supplies 640 and 641 removably attached to devices 660 and 661, respectively, according to embodiments. The contactless power supplies 640 and 641 can be similar to the contactless power supply 540 described above with respect to FIGS. 5A-5B. The devices 360 and 361 can be similar to the device 560 described above with respect to FIG. 5B. The devices 360 and 361 include a receiver module 670, a power storage module 680, an application module 690, and capacitive plates 655.

FIG. 6A shows the contactless power supply 640 removably attached to an outer portion 625 of the device 660. The outer portion 625 can correspond to, for example, a bay or cradle configured to be complimentarily fitted with the outer portion of the contactless power supply 640. In some embodiments, the contactless power supply 640 and the device 660 can each include a mating member configured to removably attach the contactless power supply 640 and the device 660. A mating member of the contactless power supply 640 can be complimentarily fitted to a mating member of the device 660. The contactless power supply 640 and the device 660 can each include at least one of a protrusion, a projection, a groove, or a depression configured to complimentarily fit the contactless power supply 640 to the device 660.

FIG. 6B shows the contactless power supply 641 removably attached to an inner portion 645 of the device 661. The inner portion 645 can correspond to, for example, a bay, space, or compartment within the device 661 that is configured to be complimentarily fitted with the outer portion of the contactless power supply 641. The device 661 can include a cover or lid (not shown) to enclose (e.g., hermetically seal) the contactless power supply 641 within the inner portion 645. In some embodiments, the contactless power supply 641 and the device 661 can each include a mating member configured to removably attach the contactless power supply 641 and the device 661. A mating member of the contactless power supply 641 can be complimentarily fitted to a mating member of the device 661. The contactless power supply 641 and the device 661 can each include a at least one of a protrusion, a projection, a groove, or a depression configured to complimentarily fit the contactless power supply 641 to the device 661.

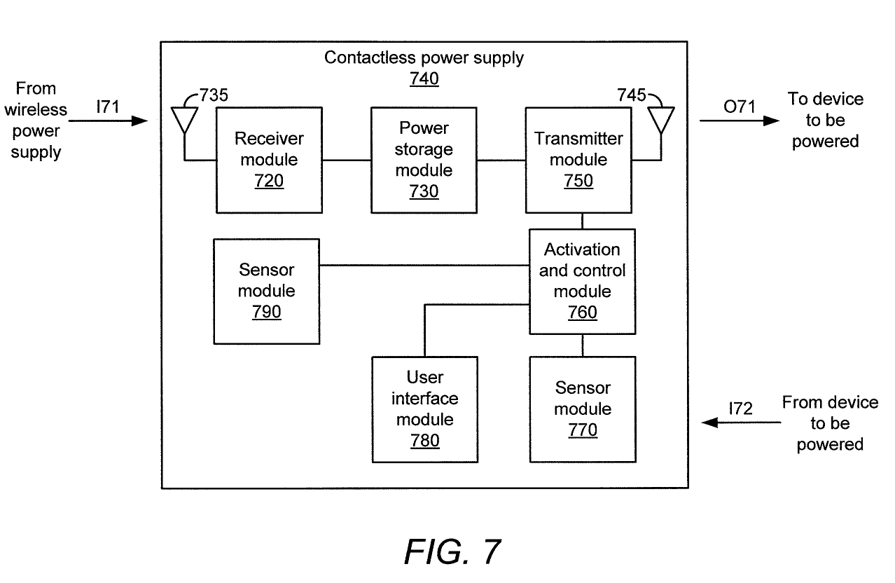

FIG. 7 is a system block diagram of a contactless power supply 740, according to an embodiment. The contactless power supply 740 includes a receiver module 720, a power storage module 730, a transmitter module 750, an activation and control module 760, a sensor module 770, and antennas 735 and 745. Optionally, the contactless power supply 740 can include a user interface module 780. The receiver module 720, the power storage module 730, the transmitter module 750, and the antennas 735 and 745 have similar functionality to the receiver module 220, the power storage module 230, the transmitter module 250, and the antennas 235 and 245, respectively, described above with respect to FIGS. 2A-2C. In this regard, the receiver module 720 is configured to receive an input 171 from a given wireless power source (not shown in FIG. 7) via the antenna 735. The input 171 includes, for example, one or more electromagnetic waves associated with a frequency band of the RF spectrum. The receiver module 720 is configured to convert the power associated with the input 171 to a DC power and send the DC power to the power storage module 730. The power storage module 730 is configured to store the DC power. The transmitter module 750 is configured to receive and convert the DC power from the power storage module 730 to one or more electromagnetic waves via the antenna 745 to produce the output O71.

The sensor module 770 is configured to detect the presence of a given device (not shown in FIG. 7) via an input 172 produced by such device. In some embodiments, an antenna (not shown) can be coupled to the sensor module 770 to receive the input 172. In other embodiments, the antenna 745 can be coupled to the sensor module 770 to receive the input 172. The input 172 can include an electric field, a magnetic field, light (e.g., infrared (IR), visible, ultraviolet (UV)), and/or one or more electromagnetic waves associated with a frequency band in the RF spectrum, for example. Alternatively, the input 172 can be a signal carrying data (e.g., device ID). The sensor module 770 is configured to produce an output (not shown) to be received by the activation and control module 760. The output produced by the sensor module 770 can include one or more signals that indicate the presence of the device and/or characteristics (e.g., type, charging requirements) associated with the device. The output produced by the sensor module 770 can include one or more signals that indicate a magnitude, level, or amount of power to be transferred wirelessly from the contactless power supply 740 to the device.

In some embodiments, the contactless power supply 740 can send a signal, such as a periodic signal (e.g., beacon signal) to indicate its presence to a nearby device. When a given nearby device detects the signal from the contactless power supply 740, the device can send a response signal to indicate its presence to the contactless power supply 740. In this regard, the sensor module 770 can be configured to detect the response signal from the device and can produce an output to be received by the activation and control module 760 that indicates the presence of the device. Alternatively, the device can send a beacon signal detected by the sensor module 770.

The activation and control module 760 is configured to enable at least a portion of the transmitter module 750 upon the device being detected by the sensor module 770. For example, the activation and control module 760 may disable the transmitter module 750 when a device has not been detected to conserve the DC power stored in the power storage module 730. Once the device is detected, the activation and control module 760 may enable the transmitter module 750 to produce the output O71 for transferring wireless power to the device. The sensor module 770 and/or the activation and control module 760 can be hardware-based or hardware-based and software-based.

The user interface module 780 can be configured to detect a user input. The user interface module 780 can be configured produce an output (not shown) to be received by the activation and control module 760. The output produced by the user interface module 780 can include one or more signals (not shown) that indicate an action to occur based on the user input. For example, the output produced by the user interface module 780 can indicate to the activation and control module 760 to enable at least a portion of the transmitter module 750. In this regard, the user interface module 780 can be used to turn ON or OFF at least a portion of the contactless power supply 740. In another example, the user interface module 780 can be used to control a magnitude, level, or amount of power to be transferred wirelessly from the contactless power supply 740 to a given device.

In another embodiment, the contactless power supply 740 can use a single antenna to receive wireless power from a wireless power source and to transfer power wirelessly to a device. In this regard, the contactless power supply 740 can include a switch (not shown in FIG. 7) configured to couple the single antenna to the receiver module 720 when receiving wireless power from a wireless power source or to the transmitter module 750 when transferring power wirelessly to a device.

In another embodiment, the contactless power supply 740 can include a sensor module 790 configured to detect the presence of a given wireless power source (not shown in FIG. 7) via an input (not shown) produced by such wireless power source. In some embodiments, an antenna (not shown) can be coupled to the sensor module 790 to receive the input from the wireless power source. The input from the wireless power source can include an electric field, a magnetic field, (e.g., IR, visible, UV), and/or one or more electromagnetic waves associated with a frequency band in the RF spectrum, for example. Alternatively, the input from the wireless power source can be a signal carrying data (e.g., source ID). The sensor module 790 can be configured to produce an output (not shown) to be received by the activation and control module 760. The output produced by the sensor module 790 can include one or more signals that indicate the presence of the wireless power source and/or characteristics (e.g., type) associated with the wireless power source. The activation and control module 760 can produce an output (not shown) indicating to the transmitter module 750 the presence of the wireless power source. The transmitter module 750 can be configured to send a signal or beacon to the wireless power source to indicate that the contactless power supply 740 has detected the presence of the wireless power supply and/or the contactless power supply 740 is ready to receive power wirelessly from the wireless power source.

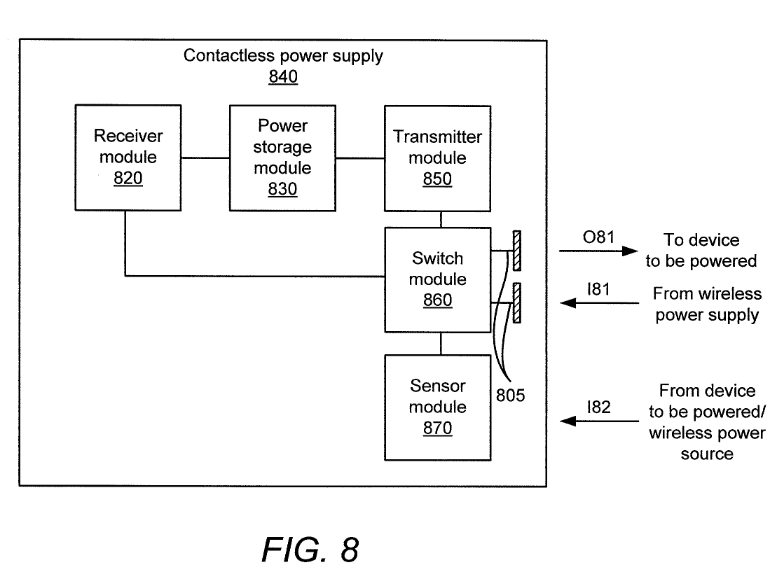

FIG. 8 is a block diagram of a contactless power supply 840, according to another embodiment. The contactless power supply 840 includes a receiver module 820, a power storage module 830, a transmitter module 850, a switch module 860, a sensor module 870, and capacitive plates 805. The receiver module 820, the power storage module 830, and the transmitter module 850 have similar functionality to the receiver module 520, the power storage module 530, and the transmitter module 550, respectively, described above with respect to FIGS. 5A-5B.

The sensor module 870 is configured to detect the presence of a given device (not shown) or a given wireless power source (not shown) via an input 182 produced by such device or such wireless power source via capacitive plates 805 or separate antenna (not shown). The input I82 can include an electric field, a magnetic field, (e.g., IR, visible, UV), and/or one or more electromagnetic waves associated with a frequency band in the RF spectrum, for example. Alternatively, the input 182 can be a signal carrying data (e.g., device ID). The sensor module 870 is configured to produce an output (not shown) to be received by the switch module 860. The output produced by the sensor module 870 can include one or more signals or pulses that indicate the presence of the device or the wireless power source and/or characteristics (e.g., type, charging requirements) associated with the device or the wireless power source.

The switch module 860 is configured to have a first position and a second position. The first position of the switch module 860 is associated with a given wireless power source being detected by the sensor module 870. The capacitive plates 805 are configured to capacitively couple the contactless power supply 840 and the wireless power source via an input 181 when the switch is in the first position. The second position of the switch module 860 is associated with a given device to be powered by the contactless power supply 840 after being detected by the sensor module 870. The capacitive plates 805 of the contactless power supply 840 are configured to capacitively couple the contactless power supply 840 and the device via an output O81 when the switch is in the second position. The switch module 860 and/or the sensor module 870 can be hardware-based or hardware-based and software-based.

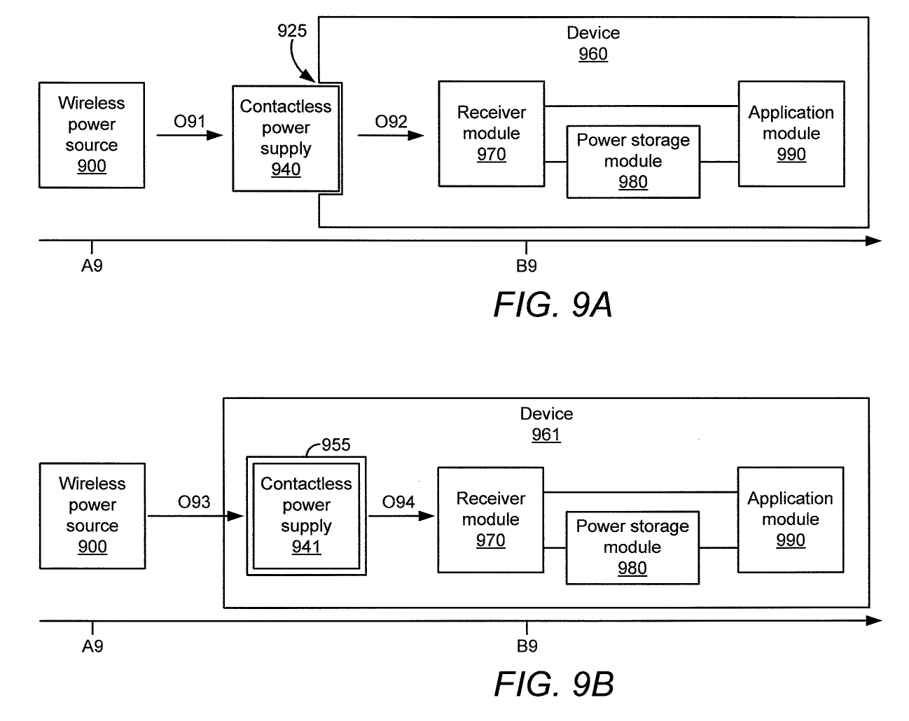

FIGS. 9A and 9B are system block diagrams of contactless power supplies 940 and 941 removably attached to devices 960 and 961, respectively, while receiving wireless power from a wireless power source 900, according to embodiments. FIG. 9A shows the contactless power supply 940 removably attached to an outer portion 925 of the device 960 similar to those described above with respect to FIGS. 3C and 6A. The device 960 includes a receiver module 970, a power storage module 980, and an application module 990. The contactless power supply 940 receives an output O91 from the wireless power source 900 to wirelessly transfer power to the contactless power supply 940. In some embodiments, the output O91 can include one or more electromagnetic waves associated with a frequency band in the RF spectrum. In other embodiments, the output O91 can include an electric field associated with wireless transfer via capacitive coupling.

The contactless power supply 940 can convert the wireless power received from the wireless power source 900 to DC power. The contactless power supply 940 can convert the DC power to an output O92 that can be received by the receiver module 970 of the device 960. In some embodiments, the output O92 can include one or more electromagnetic waves associated with a frequency band in the RF spectrum. In other embodiments, the output O92 can include an electric field associated with wireless transfer via capacitive coupling.

FIG. 9B shows the contactless power supply 941 removably attached to an inner portion 955 of the device 961 similar to those described above with respect to FIGS. 3D and 6B. The device 961 includes the receiver module 970, the power storage module 980, and the application module 990. The contactless power supply 941 receives an output O93 from the wireless power source 900 to wirelessly transfer power to the contactless power supply 941. In some embodiments, the output O93 can include one or more electromagnetic waves associated with a frequency band in the RF spectrum. In other embodiments, the output O93 can include an electric field associated with wireless transfer via capacitive coupling.

The contactless power supply 941 can convert the wireless power received from the wireless power source 900 to DC power. The contactless power supply 941 can convert the DC power to an output O94 that can be received by the receiver module 970 of the device 961. In some embodiments, the output O94 can include one or more electromagnetic waves associated with a frequency band in the RF spectrum. In other embodiments, the output O94 can include an electric field associated with wireless transfer via capacitive coupling.

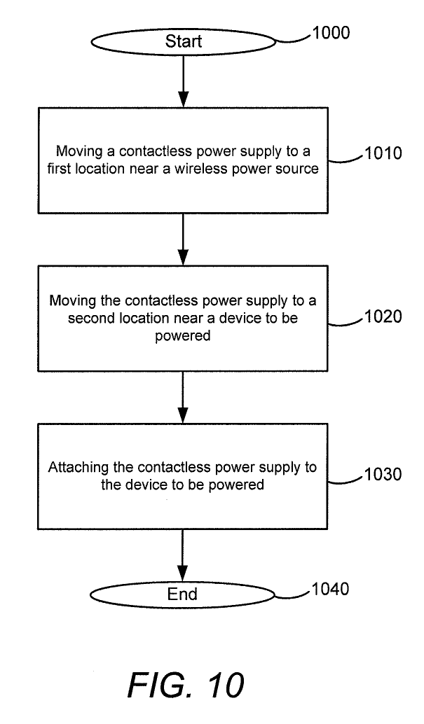

FIG. 10 is a flow chart illustrating a method for wireless transmission of power using a contactless power supply, according to an embodiment. After start 1000, at 1010, a contactless power supply is moved to a first location within a wireless-power threshold associated with a power source (e.g., a wireless power source). The contactless power supply is configured to receive a first wireless power from the power source when in the first location. The first location can be associated with a non-hazardous place, environment, or condition, for example. The contactless power supply is configured to convert the first wireless power to a first DC power.

At 1020, the contactless power supply is moved to a second location such that a device is within a wireless-power threshold associated with the contactless power supply. The second location can be associated with a hazardous place, environment, or condition, for example. The contactless power supply is configured to convert the first DC power to a second wireless power via an antenna when in the second location. The device is configured to convert the second wireless power to a second DC power. At 1030, the contactless power supply is removably attached to the device. The device is configured to receive the second wireless power from the contactless power supply. After 1030, the process proceeds to end 1040.

### CONCLUSION

While various embodiments have been described above, it should be understood that they have been presented by way of example only, and not limitation. For example, the contactless power supply described herein can include various combinations and/or sub-combinations of the components and/or features of the different embodiments described. It should be understood that the contactless power supply can receive power from more than one wireless power source and that the contactless power supply can send power to more than one device to be powered.

Some embodiments include a processor and a related processor-readable medium having instructions or computer code thereon for performing various processor-implemented operations. Such processors can be implemented as hardware modules such as embedded microprocessors, microprocessors as part of a computer system, Application-Specific Integrated Circuits (“ASICs”), and Programmable Logic Devices (“PLDs”). Such processors can also be implemented as one or more software modules in programming languages as Java, C++, C, assembly, a hardware description language, or any other suitable programming language.

A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention can be implemented using Java, C++, or other object-oriented programming language and development tools. Additional examples of computer code include, but are not limited to, control signals, encrypted code, and compressed code.

What is claimed is:

1. A system, comprising:
a first device configured to receive a first wireless power associated with a first electromagnetic wave from a wireless power source, the first device configured to convert the first wireless power to a first DC power, the first device configured to store the first DC power, the first device configured to convert the first DC power stored in the first device to a second wireless power associated with a second electromagnetic wave via an antenna; and
a second device configured to receive the second wireless power from the first device, the second device configured to convert the second wireless power to a second DC power.

2. The system of claim 1, wherein the second device is configured to store the second DC power.

3. The system of claim 1, wherein:
the first device is configured to receive the first wireless power associated with the first electromagnetic wave at a first location, and
the first device is configured to convert the first DC power stored in the first device to the second wireless power at a second location different from the first location.

4. The system of claim 1, wherein the first device includes:
a sensor module configured to detect the second device via an input received from the second device; and
an activation module configured to enable at least a portion of the first device upon the second device being detected by the sensor module.

5. The system of claim 1, wherein:
the first electromagnetic wave is associated with a first radio frequency band, and
the second electromagnetic wave is associated with a second radio frequency band different from the first radio frequency band.

6. The system of claim 1, wherein the first device includes:
a user interface configured to detect a user input; and
an activation module configured to enable at least at least a portion of the first device based on the user input.

7. The system of claim 1, wherein the first device is configured to be removably attached to the second device.

8. The system of claim 1, wherein the first device is configured to be complimentarily fitted to at least one of an outside portion of the second device or an inside portion of the second device.

9. The system of claim 1, wherein the first device is configured to be complimentarily fitted to at least one of an outside portion of the wireless power source or an inside portion of the wireless power source.

10. The system of claim 1, wherein the first device includes a first mating member, the second device includes a second mating member, the first mating member of the first device and the second mating member of the second device configured to removably attach the first device to the second device.

11. The system of claim 1, wherein the first device and the second device each includes at least one of a protrusion, a projection, a groove, or a depression configured to complimentarily fit the first device to the second device.

12. The system of claim 1, wherein the first device is hermetically sealed.

13. The system of claim 1, further comprises:
the wireless power source.

14. The system of claim 1, further comprises:
the wireless power source, the first device and the wireless power source each includes at least one of a protrusion, a projection, a groove, or a depression configured to complimentarily fit the first device to the wireless power source.

15. The system of claim 1, further comprises:
the wireless power source, the first device having a first mating member and the wireless power source having a second mating member, the first mating member of the first device and the second mating member of the wireless power source configured to removably attach the first device to the wireless power source.

16. A system, comprising:
a first device configured to receive a first wireless power from a power source, the first device configured to convert the first wireless power to a first DC power, the first device configured to store the first DC power, the first device configured to convert the first DC power stored in the first device to a second wireless power; and
a second device configured to receive the second wireless power from the first device, the second device configured to convert the second wireless power to a second DC power.

17. A system, comprising:
a first device having at least two capacitive plates configured to receive a first wireless power from a power source via capacitive coupling, the first device configured to convert the first wireless power to a first DC power, the first device configured to store the first DC power, the first device configured to convert the first DC power stored in the first device to a second wireless power via capacitive coupling; and
a second device having at least two capacitive plates configured to receive the second wireless power from the first device, the second device configured to convert the second wireless power to a second DC power.

18. The system of claim 17, wherein the at least two capacitive plates of the first device include:
a first set of capacitive plates configured to capacitively couple the first device and the power source; and
a second set of capacitive plates configured to capacitively couple the first device and the second device.

19. The system of claim 17, wherein the first device includes:
a switch having a first position and a second position, the at least two capacitive plates of the first device being configured to capacitively couple the first device and the power source when the switch is in the first position, the at least two capacitive plates of the first device being configured to capacitively couple the first device and the second device when the switch is in the second position.

20. The system of claim 17, wherein the at least two capacitive plates of the first device include:
a first set of capacitive plates configured to capacitively couple the first device and the power source via a first frequency band,
the second set of capacitive plates being configured to capacitively couple the first device and the second device via a second frequency band different from the first frequency band.

21. The system of claim 17, wherein the first device includes:
a sensor module configured to detect the second device via an input received from the second device through the at least two capacitive plates of the first device; and
an activation module configured to enable at least a portion of the first device upon second device being detected by the sensor module.

22. A method, comprising:
moving a first device to a first location within a wireless-power threshold associated with a power source, the first device configured to receive a first wireless power from the power source when in the first location, the first device configured to convert the first wireless power to a first DC power; and
moving the first device to a second location such that a second device is within a wireless-power threshold associated with the first device, the first device configured to convert the first DC power to a second wireless power when in the second location, the second device configured to receive the second wireless power from the first device, the second device configured to convert the second wireless power to a second DC power.

23. The method of claim 22, further comprising removably attaching the first device to the second device.

24. The method of claim 22, wherein a maximum distance between the power source and the first device based on the wireless-power threshold associated with the power source is different from a maximum distance between the first device and the second device based on the wireless-power threshold associated with the first device.

25. An apparatus, comprising:
a receiver configured to receive a first wireless power, the receiver configured to convert the first wireless power to a first DC power;
a power storage module configured receive the first DC power from the receiver, the power storage module configured to store the first DC power;
a transmitter configured to receive the first DC power from the power storage module, the transmitter configured to convert the first DC power to a second wireless power via an antenna; and
a housing within which the receiver, the power storage module, and the transmitter are disposed,
the transmitter configured to transmit the second wireless power via the antenna to a device separate from the housing such that the device receives the second wireless power from the transmitter and converts the second wireless power to a second DC power.

26. An apparatus, comprising:
a receiver configured to receive a first wireless power, the receiver configured to convert the first wireless power to a first DC power;
a power storage module configured receive the first DC power from the receiver, the power storage module configured to store the first DC power;
a transmitter configured to receive the first DC power from the power storage module, the transmitter configured to convert the first DC power to a second wireless power via capacitive plates; and
a housing within which the receiver, the power storage module, and the transmitter are disposed,
the transmitter configured to transmit the second wireless power via the capacitive plates to a device separate from the housing such that the device receives the second wireless power from the transmitter and converts the second wireless power to a second DC power.
